(19) United States
(12) Patent Application Publication
(10) Pub. No.: US 2021/0264261 A1
(43) Pub. Date: Aug. 26, 2021

(54) SYSTEMS AND METHODS FOR FEW SHOT OBJECT DETECTION

(71) Applicant: CACI, Inc. - Federal, Arlington, VA (US)

(72) Inventors: Tyler Staudinger, Denver, CO (US); Ross Massey, Arlington, VA (US)

(73) Assignee: CACI, Inc. - Federal, Arlington, VA (US)

(21) Appl. No.: 17/120,372

(22) Filed: Dec. 14, 2020

Related U.S. Application Data
(60) Provisional application No. 62/979,810, filed on Feb. 21, 2020.

(51) Int. Cl. G06N 3/08; G06N 3/04; G06K 9/00; G06K 9/62

(52) U.S. Cl. CPC G06N 3/08; G06N 3/0445; G06K 9/6256; G06K 9/6215; G06K 9/00718

(57) ABSTRACT

A system may be configured to detect an unseen object. Some embodiments may: train a machine learning (ML) model, with training data and with both a positive-support content item and a negative-support content item; and predict, via the trained ML model, presence, within a region, of an object in a newly-obtained content item. The object may (i) not have previously been used to train the ML model and (ii) be among a background and a candidate object present in the newly-obtained content item.

### CROSS-REFERENCE TO RELATED APPLICATIONS

This application claims the benefit of the priority date of U.S. provisional application 62/979,810 filed on Feb. 21, 2020 and entitled “Method and Apparatus for Object Detection and Prediction Employing Neural Networks,” the content of which is incorporated by reference herein in its entirety. This disclosure relates to (i) U.S. provisional application 62/979,801 filed on Feb. 21, 2020, (ii) U.S. nonprovisional application concurrently filed herewith under Docket No. 046850.025221 as “Machine Learning Method and Apparatus for Detection and Continuous Feature Comparison,” (iii) U.S. nonprovisional application concurrently filed herewith under Docket No. 046850.025281 as “Reasoning from Surveillance Video via Computer Vision-Based Multi-Object Tracking and Spatiotemporal Proximity Graphs,” (iv) U.S. provisional application 62/979,824 filed on Feb. 21, 2020, and (iv) U.S. nonprovisional application concurrently filed herewith under Docket No. 046850.025211 as “Systems and Methods for Labeling Data,” the content of each of which being incorporated by reference herein in its entirety.

### TECHNICAL FIELD

The present disclosure relates generally to systems and methods for predicting presence in input media of an object of an unseen or novel category, with few annotated examples.

### BACKGROUND

Modern object detection neural networks require vast amounts of hand-labeled data in order to learn a new class. And the training process may take a large amount of time, which is typically performed offline. Acquisition of the data may further prove difficult. In addition, labeling the acquired data is time-consuming and expensive.

Conventional object detection models are incapable of predicting a novel class without retraining. That is, such neural networks are limited to the training classes in deployment, i.e., when there is not much if any data, computing power, or time to retrain the model for the novel class. Further, assumptions are often violated in model deployment.

### SUMMARY

Systems and methods are disclosed for inferring presence of one or more unseen objects. Accordingly, one or more aspects of the present disclosure relate to a method for detecting the one or more unseen objects, e.g., by: training a machine learning (ML) model with training data and one or more positive-support content items; and predicting, via the trained ML model and a similarity model that computes a regional-similarity score, presence, within a region, of an object in a newly-obtained content item. The object may (i) not have previously been used to train the ML model and (ii) be among a background and a candidate object present in the newly-obtained content item. The ML model may, in some embodiments, be further trained with one or more negative-support content items. And weights may be shared between the prediction and the training of a backbone neural network that comprises the ML model.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which presence of rare objects is predicted from query content, in accordance with one or more embodiments.

FIG. 2 illustrates an exemplary procedure for training the neural networks used in the prediction, in accordance with one or more embodiments.

FIG. 3 illustrates an exemplary procedure for inferring presence of the rare object, in accordance with one or more embodiments.

FIG. 4 illustrates an exemplary prediction of the rare object, in accordance with one or more embodiments.

FIG. 5 illustrates a process for predicting presence of a rare object, in accordance with one or more embodiments.

FIG. 6 illustrates a process for predicting presence of a rare object, in accordance with one or more embodiments.

FIG. 7 illustrates a process for predicting presence of different, rare objects, in accordance with one or more embodiments.

### DETAILED DESCRIPTION

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

Presently disclosed are ways of localizing an unseen object in a cluttered background from few annotated examples. The localization may be performed from among media, which may be any type of content, but for the sake of a clear explanation, most of the examples provided herein relate to images of a video stream. The query and support content items may be captured with any suitable sensor, such as a light exposure sensor or camera (e.g., to capture colors and sizes of objects), but these inputted content items may be captured with any other type of sensor, such as a motion sensor, infrared sensor, oxygen sensor, temperature sensor, video camera, infrared (IR) sensor, microwave sensor, LIDAR, microphone, olfactory sensor, haptic sensor, bodily secretion sensor (e.g., pheromones), ultrasound sensor, or another sensing device.

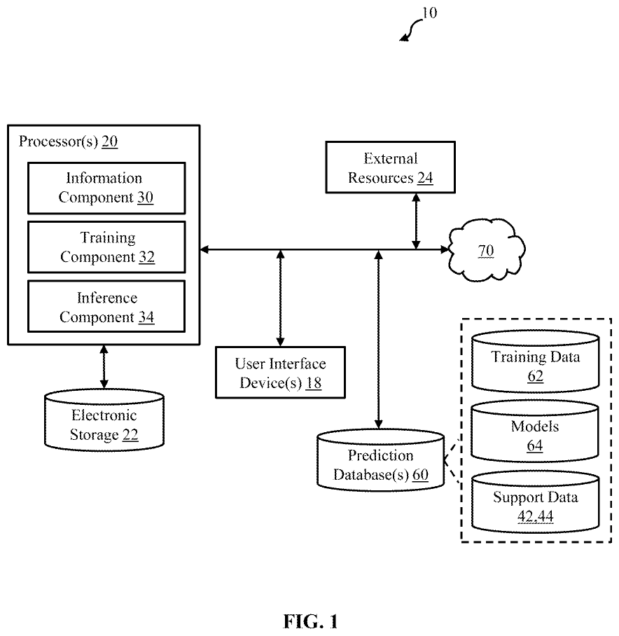

FIG. 1 illustrates system 10 configured to detect a rare or novel object. An object may be so distinguished by having an extremely small volume of available data in which to train. And this unseen object may not previously have been used to train the ML model used in prediction. Few shot detection is thus a way to learn novel objects for detection, with very little data.

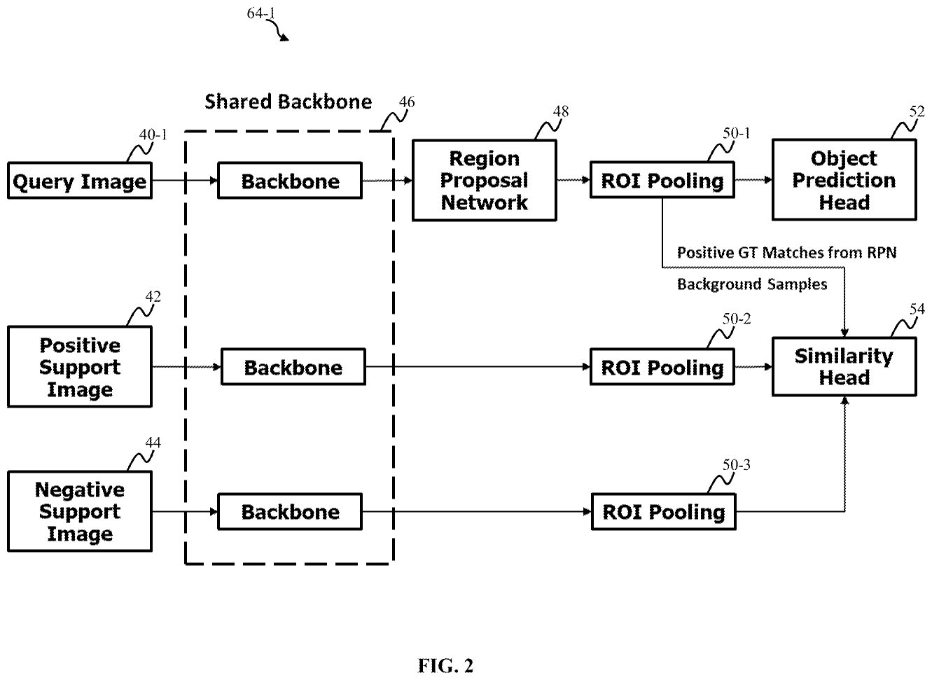

The disclosed approach includes three heads, as depicted in FIG. 2: object prediction head 52, similarity head 54, and a head for training shared backbone 46 with one or more negative support images 44. Shared backbone 46 may be further trained with training data 62 and with one or more positive support images 42. As such, a learning process associated with the training of backbone 46 may be shortened by an amount of time that satisfies a criterion.

System 10 may, e.g., perform few shot object detection with object prediction head 52 and similarity head 54. For example, a user may be operable to select a novel object of interest, and system 10 may then immediately make predictions for the new class. This may be performed when presented with only a single or a handful of samples. Trained neural networks 64-2 may thus be deployed, e.g., for performing detection and prediction of an object of interest.

Herein-disclosed models 64 may include an extension of the faster recurrent convolutional neural network (faster R-CNN) architecture, e.g., with addition of region of interest (ROI) pooling 50-2 and similarity prediction head 54. To train these models, a query image, positive support(s), and negative support(s) may be provided into feature extraction backbone 46 of models 64. Query image 40 may, e.g., be one or more images with respect to which system 10 intends to make predictions; positive support(s) may be, e.g., one or more images of the object(s) desirable for detecting, which may potentially be zoomed-in and/or centered around said object; and negative support(s) may be, e.g., one or more images that are (i) of a different class or type from the object(s) desirable for detecting and (ii) likely to be present in query 40. Negative support 44 may cause models 64-2 to be more discriminative in terms of the feature representations, e.g., by comprising an object the presence of which models 64-2 is not intended to predict. As such, the quality of the feature vectors may be improved upon, by pushing apart the desirable objects from the undesirable objects within the feature space, to better predict presence of the desirable object(s).

In some embodiments, feature vectors, from query image 40, may be generated by backbone 46 and used to predict all possible candidate objects that could be in the query image(s). Before, concurrent-with, or after these predictions (e.g., which may be made with respect to object prediction head 52), positive and negative support images 42,44 may be provided into ROI pooling units 50-2 and 50-3 such that similarity predictions are made thereof.

In some embodiments, similarity head 54 may be trained to predict whether a region from the query image(s) matches a region of one of the positive support images. Once trained, few shot detection models 64 may be capable of deployment to real-world applications where novel classes may be registered at any time using only a few annotated examples (i.e., one or more of each of positive-support content 42 and/or negative-support content 44). These models may thus predict presence of all target objects belonging to the support category in the query and label them with tight bounding boxes. The detections may not be performed perfectly, e.g., but with an amount of jitter or with an amount of missed predictions that satisfies a quality criterion. As such, the quality may be comparable to traditional detection methods that require thousands or hundreds of thousands of samples.

In some embodiments, the herein-disclosed few shot detector may be incremental. In other embodiments, said detector may be non-incremental.

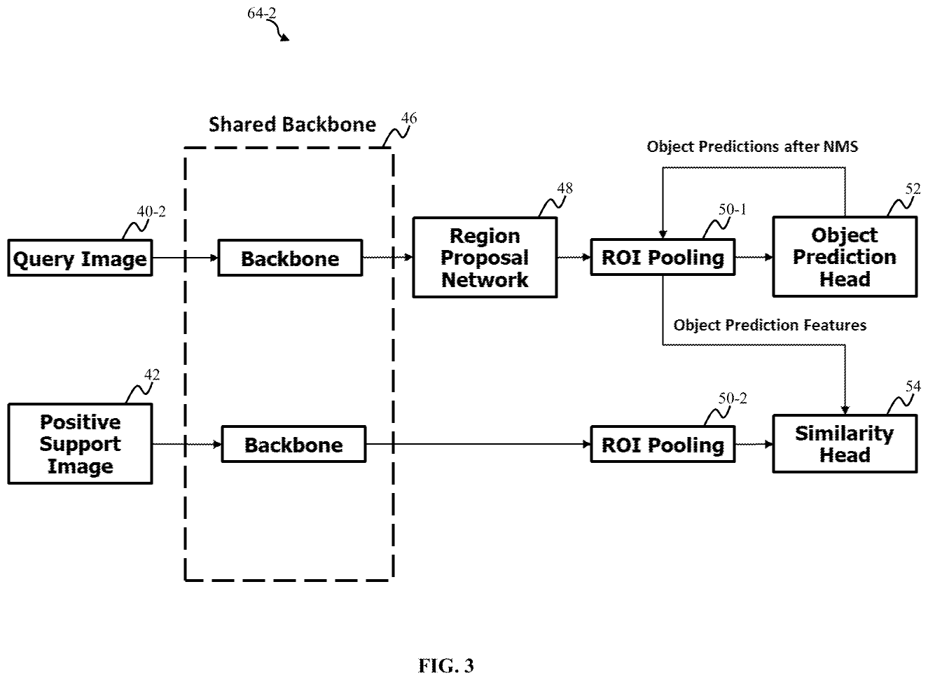

In some embodiments, after exposing models 64-1 of FIG. 2 to a single positive support example, models 64-2 of FIG. 3 may be deployed to detect all instances of an unseen object (e.g., which is of a same type as the single example), in a series of frames or images. The unseen object in the query image and an object in a positive support image may be slightly different, e.g., comprising a different background, comprising different instances of a same type of the object, and/or being captured at different times.

Artificial neural networks (ANNs) are models used in machine learning and may include statistical learning algorithms conceived from biological neural networks (particularly of the brain in the central nervous system of an animal) in machine learning and cognitive science. ANNs may refer generally to models that have artificial neurons (nodes) forming a network through synaptic interconnections (weights), and acquires problem-solving capability as the strengths of the interconnections are adjusted, e.g., at least throughout training. The terms ‘artificial neural network’ and ‘neural network’ may be used interchangeably herein.

An ANN may be configured to determine a classification (e.g., type of object) based on input image(s) or other sensed information. An ANN is a network or circuit of artificial neurons or nodes. Such artificial networks may be used for predictive modeling.

The prediction models may be and/or include one or more neural networks (e.g., deep neural networks, artificial neural networks, or other neural networks), other machine learning models, or other prediction models. As an example, the neural networks referred to variously herein may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections may be enforcing or inhibitory, in their effect on the activation state of connected neural units. These neural network systems may be self-learning and trained, rather than explicitly programmed, and may perform significantly better in certain areas of problem solving, as compared to traditional computer programs. In some embodiments, neural networks may include multiple layers (e.g., where a signal path traverses from input layers to output layers). In some embodiments, back propagation techniques may be utilized to train the neural networks, where forward stimulation is used to reset weights on the front neural units. In some embodiments, stimulation and inhibition for neural networks may be more free-flowing, with connections interacting in a more chaotic and complex fashion.

Disclosed implementations of artificial neural networks may apply a weight and transform the input data by applying a function, this transformation being a neural layer. The function may be linear or, more preferably, a nonlinear activation function, such as a logistic sigmoid, hyperbolic tangent (Tanh), or rectified linear activation function (ReLU) function. Intermediate outputs of one layer may be used as the input into a next layer. The neural network through repeated transformations learns multiple layers that may be combined into a final layer that makes predictions. This learning (i.e., training) may be performed by varying weights or parameters to minimize the difference between the predictions and expected values. In some embodiments, information may be fed forward from one layer to the next. In these or other embodiments, the neural network may have memory or feedback loops that form, e.g., a neural network. Some embodiments may cause parameters to be adjusted, e.g., via back-propagation.

Each of the herein-disclosed ANNs may be characterized by features of its model, the features including an activation function, a loss or cost function, a learning algorithm, an optimization algorithm, and so forth. The structure of an ANN may be determined by a number of factors, including the number of hidden layers, the number of hidden nodes included in each hidden layer, input feature vectors, target feature vectors, and so forth. Hyperparameters may include various parameters which need to be initially set for learning, much like the initial values of model parameters. The model parameters may include various parameters sought to be determined through learning. And the hyperparameters are set before learning, and model parameters can be set through learning to specify the architecture of the ANN.

Learning rate and accuracy of each ANN may rely not only on the structure and learning optimization algorithms of the ANN but also on the hyperparameters thereof. Therefore, in order to obtain a good learning model, it is important to choose a proper structure and learning algorithms for the ANN, but also to choose proper hyperparameters. The hyperparameters may include initial values of weights and biases between nodes, mini-batch size, iteration number, learning rate, and so forth. Furthermore, the model parameters may include a weight between nodes, a bias between nodes, and so forth. In general, the ANN is first trained by experimentally setting hyperparameters to various values, and based on the results of training, the hyperparameters can be set to optimal values that provide a stable learning rate and accuracy.

Some embodiments of models 64 may comprise (e.g., for shared backbone 46) a CNN. A CNN may comprise an input and an output layer, as well as multiple hidden layers. The hidden layers of a CNN typically comprise a series of convolutional layers that convolve with a multiplication or other dot product. The activation function is commonly a RELU layer, and is subsequently followed by additional convolutions such as pooling layers, fully connected layers and normalization layers, referred to as hidden layers because their inputs and outputs are masked by the activation function and final convolution.

The CNN computes an output value by applying a specific function to the input values coming from the receptive field in the previous layer. The function that is applied to the input values is determined by a vector of weights and a bias (typically real numbers). Learning, in a neural network, progresses by making iterative adjustments to these biases and weights. The vector of weights and the bias are called filters and represent particular features of the input (e.g., a particular shape).

A recurrent neural network (RNN) is a class of artificial neural networks where connections between nodes form a directed graph along a temporal sequence. Temporal dynamic behavior can be shown from the graph. RNNs employ internal state memory to process variable length sequences of inputs.

In some embodiments, the learning of models 64 may be of reinforcement, supervised, and/or unsupervised type. For example, there may be a model for certain predictions that is learned with one of these types but another model for other predictions may be learned with another of these types.

Reinforcement learning is a technique in the field of artificial intelligence where a learning agent interacts with an environment and receives observations characterizing a current state of the environment. Namely, a deep reinforcement learning network is trained in a deep learning process to improve its intelligence for effectively making predictions. The training of a deep learning network may be referred to as a deep learning method or process. The deep learning network may be a neural network, Q-learning network, dueling network, or any other applicable network.

Reinforcement learning may be based on a theory that given the condition under which a reinforcement learning agent can determine what action to choose at each time instance, the agent can find an optimal path to a solution solely based on experience of its interaction with the environment. For example, reinforcement learning may be performed mainly through a Markov decision process (MDP). MDP may comprise four stages: first, an aunt is given a condition containing information required for performing a next action; second, how the agent behaves in the condition is defined; third, which actions the agent should choose to get rewards and which actions to choose to get penalties are defined; and fourth, the agent iterates until a future reward is maximized, thereby deriving an optimal policy.

Deep reinforcement learning (DRL) techniques capture the complexities of an environment in a model-free manner and learn about it from direct observation. DRL can be deployed in different ways such as for example via a centralized controller, hierarchal or in a fully distributed manner. There are many DRL algorithms and examples of their applications to various environments. In some embodiments, deep learning techniques may be used to solve complicated decision-making problems. For example, deep learning networks may be trained to adjust one or more parameters of a network with respect to an optimization goal.

Supervised learning is the machine learning task of learning a function that maps an input to an output based on example input-output pairs. It may infer a function from labeled training data comprising a set of training examples. In supervised learning, each example is a pair consisting of an input object (typically a vector) and a desired output value (the supervisory signal). A supervised learning algorithm analyzes the training data and produces an inferred function, which can be used for mapping new examples. And the algorithm may correctly determine the class labels for unseen instances.

Unsupervised learning is a type of machine learning that looks for previously undetected patterns in a dataset with no pre-existing labels. In contrast to supervised learning that usually makes use of human-labeled data, unsupervised learning does not via principal component (e.g., to preprocess and reduce the dimensionality of high-dimensional datasets while preserving the original structure and relationships inherent to the original dataset) and cluster analysis (e.g., which identifies commonalities in the data and reacts based on the presence or absence of such commonalities in each new piece of data). Semi-supervised learning is also contemplated, which makes use of supervised and unsupervised techniques.

Training component 32 of FIG. 1 may prepare one or more prediction models 64 to generate predictions. Models 64 may analyze made predictions against a reference set of data called the validation set. In some use cases, the reference outputs may be provided as input to the prediction models, which the prediction model may utilize to determine whether its predictions are accurate, to determine the level of accuracy or completeness with respect to the validation set data, or to make other determinations. Such determinations may be utilized by the prediction models to improve the accuracy or completeness of their predictions. In another use case, accuracy or completeness indications with respect to the prediction models' predictions may be provided to the prediction model, which, in turn, may utilize the accuracy or completeness indications to improve the accuracy or completeness of its predictions with respect to input data. For example, a labeled training dataset may enable model improvement. That is, the training model may use a validation set of data to iterate over model parameters until the point where it arrives at a final set of parameters/weights to use in the model.

In some embodiments, training component 32 may implement an algorithm for building and training one or more deep neural networks, e.g., backbone 46, region proposal network (RPN) 48, object prediction head 52, and/or similarity head 54. In some embodiments, training component 32 may train a deep learning model on training data 62 providing even more accuracy, after successful tests with this algorithm are performed and after the model is provided a large enough dataset.

A model implementing a neural network may be trained using training data obtained by information component 30 from training data 62 storage/database. The training data may include many attributes of objects or other portions of a content item. For example, this training data obtained from prediction database 60 of FIG. 1 may comprise hundreds, thousands, or even many millions of pieces of information (e.g., images or other sensed data) describing objects. The dataset may be split between training, validation, and test sets in any suitable fashion. For example, some embodiments may use about 60% or 80% of the images for training or validation, and the other about 40% or 20% may be used for validation or testing. In another example, training component 32 may randomly split the labelled images, the exact ratio of training versus test data varying throughout. When a satisfactory model is found, training component 32 may, e.g., train it on 95% of the training data and validate it further on the remaining 5%.

The validation set may be a subset of the training data, which is kept hidden from the model to test accuracy of the model. The test set may be a dataset, which is new to the model to test accuracy of the model. The training dataset used to train prediction models 64 may leverage, via inference component 34, an SQL server, and/or a Pivotal Greenplum database for data storage and extraction purposes.

In some embodiments, training component 32 may be configured to obtain training data from any suitable source, via electronic storage 22, external resources 24 (e.g., which may include sensors), network 70, and/or user interface (UI) device(s) 18. The training data may comprise captured images, smells, light/colors, shape sizes, noises or other sounds, and/or other discrete instances of sensed information.

In some embodiments, training component 32 may enable one or more prediction models 64-1 to be trained. The training of the neural networks may be performed via several iterations. For each training iteration, a classification prediction (e.g., output of a layer) of the neural network(s) may be determined and compared to the corresponding, known classification. For example, sensed data known to capture an environment comprising dynamic and/or static objects may be input, during the training or validation, into the neural network to determine whether the prediction model may properly predict an unseen object's presence therein. As such, the neural networks may be configured to receive at least a portion of the training data as an input feature space. Once trained, the model(s) may be stored in database/storage 64 of prediction database 60, as shown in FIG. 1, and then used to classify samples of images based on attributes.

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface device 18, processor 20, etc.). In some embodiments, electronic storage 22 may be located in a server together with processor 20, in a server that is part of external resources 24, in user interface devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via user interface devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a set of graphics processing units (GPUs), and/or other resources. In some implementations, some or all of the functionality attributed herein to external resources 24 may be provided by other components or resources included in system 10. Processor 20, external resources 24, UI device 18, electronic storage 22, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, IR, ultraviolet (UV), visible light, cm wave, mm wave, etc.), a base station, and/or other resources.

UI device(s) 18 of system 10 may be configured to provide an interface between one or more users and system 10. UI devices 18 are configured to provide information to and/or receive information from the one or more users. UI devices 18 include a UI and/or other components. The UI may be and/or include a graphical UI (GUI) configured to present views and/or fields configured to receive entry and/or selection with respect to particular functionality of system 10, and/or provide and/or receive other information. In some embodiments, the UI of UI devices 18 may include a plurality of separate interfaces associated with processors 20 and/or other components of system 10. Examples of interface devices suitable for inclusion in UI device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that UI devices 18 include a removable storage interface. In this example, information may be loaded into UI devices 18 from removable storage (e.g., a smart card, a flash drive, a removable disk) that enables users to customize the implementation of UI devices 18.

In some embodiments, UI devices 18 are configured to provide a UI, processing capabilities, databases, and/or electronic storage to system 10. As such, UI devices 18 may include processors 20, electronic storage 22, external resources 24, and/or other components of system 10. In some embodiments, UI devices 18 are connected to a network (e.g., the Internet). In some embodiments, UI devices 18 do not include processor 20, electronic storage 22, external resources 24, and/or other components of system 10, but instead communicate with these components via dedicated lines, a bus, a switch, network, or other communication means. The communication may be wireless or wired. In some embodiments, UI devices 18 are laptops, desktop computers, smartphones, tablet computers, and/or other UI devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol Version 4 (IPv4) and Internet Protocol Version 6 (IPv6).

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) googles, virtual reality (VR) googles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, user interface devices 18, devices that are part of external resources 24, electronic storage 22, and/or other devices).

As shown in FIG. 1, processor 20 is configured via machine-readable instructions to execute one or more computer program components. The computer program components may comprise one or more of information component 30, training component 32, inference component 34, and/or other components. Processor 20 may be configured to execute components 30, 32, and/or 34 by: software; hardware; firmware; some combination of software, hardware, and/or firmware; and/or other mechanisms for configuring processing capabilities on processor 20.

It should be appreciated that although components 30, 32, and 34 are illustrated in FIG. 1 as being co-located within a single processing unit, in embodiments in which processor 20 comprises multiple processing units, one or more of components 30, 32, and/or 34 may be located remotely from the other components. For example, in some embodiments, each of processor components 30, 32, and 34 may comprise a separate and distinct set of processors. The description of the functionality provided by the different components 30, 32, and/or 34 described below is for illustrative purposes, and is not intended to be limiting, as any of components 30, 32, and/or 34 may provide more or less functionality than is described. For example, one or more of components 30, 32, and/or 34 may be eliminated, and some or all of its functionality may be provided by other components 30, 32, and/or 34. As another example, processor 20 may be configured to execute one or more additional components that may perform some or all of the functionality attributed below to one of components 30, 32, and/or 34.

In some embodiments, information component 30 is configured to initially obtain training images from electronic storage 22. external resources 24, and/or via user interface device(s) 18. In some embodiments, information component 30 is connected to network 70. The connection to network 70 may be wireless or wired.

In some embodiments, training component 32 and/or inference component 34 may cause implementation of deep learning. The deep learning may be performed via one or more ANNs.

Each model of prediction models 64 may include an input layer, one or more other layers, and an output layer. The one or more other layers may comprise a convolutional layer, activation layer, and/or pooling layer. The number and type of layers is not intended to be limiting. Artificial neurons may perform calculations using one or more parameters, and there may be connections from the output of one neuron to the input of another. The extracted features from multiple independent paths of attribute detectors may, e.g., be combined. For example, their outputs may be fed as a single input vector to a fully connected neural network to produce a prediction on the class of an object in the image.

Each of the layers of the neural networks of object prediction head 52 and/or similarity head 54 may comprise a plurality of nodes or neurons. And each of these heads may, e.g., have one or more fully connected layers. For example, object prediction head 52 may have said layers for regressing the output coordinates as well as for the classification. In some embodiments, there may be fully connected layers in prediction heads 52 and 54.

R-CNN may use selective search to extract regions of interest (ROIs), where each ROI is a polygon that most probably represents the boundary of an object in image. For each ROIs' output features, a collection of support-vector machine classifiers may be used to determine what type of object (if any) is contained within the ROI.

Fast R-CNN may run a neural network once on the whole image, and it may conclude with an ROI pooling layer, which may slice out each ROI from the network's output tensor, reshape it, and classify it. As in the original R-CNN, fast R-CNN uses selective search to generate its region proposals. The architecture is trained end-to-end with a multi-task loss.

Faster R-CNN integrates the ROI generation into the neural network itself. Faster R-CNN solves bottlenecked CNN by abandoning the traditional region proposal method, and relying on a fully deep learning approach. It may comprise two modules: a region proposal network (RPN) CNN and a fast R-CNN detector. Faster R-CNN may use a classifier with two possible classes: one for having an object and the other for background class. Faster R-CNN may be used to predict offsets like δx, 67 y that are relative to the top left corner of some reference boxes (which encode proposals, the proposal being parametrized with coordinates of polygonal vertices relative to an anchor, for example) called anchors. Anchors are also called priors or default boundary boxes.

A mask R-CNN may be a fully convolutional head for predicting masks, which may resize the prediction and generate the mask. These region-based techniques may limit a classifier to the specific region. Mask R-CNN may perform instance segmentation and the ROI align function, and thus bilinear interpolation to compute the exact values of the input features. The first stage (region proposal) of mask R-CNN may be identical to faster R-CNN, while in the second stage it may output a binary mask for each ROI in parallel to the class and bounding box. This binary mask denotes whether the pixel is part of any object, without concern for the categories.

By contrast, a you only look once (YOLO) technique may access the whole image in predicting boundaries, and it may: (i) detect in real-time which objects are where; (ii) predict bounding boxes; and/or (iii) give a confidence score for each prediction of an object being in the bounding box and of a class of that object by dividing an image into a grid of bounding boxes; each grid cell may be evaluated to predict only one object. As such, YOLO may be used to build a CNN network to predict a tensor, wherein the bounding boxes or ROIs are selected for each portion of the image. YOLO only needs one forward propagation to detect all objects in an image. And YOLO models object detection as a regression problem.

With respect to the aforementioned approaches, Mesh R-CNN adds the ability to generate a three-dimensional (3D) mesh from a two-dimensional (2D) image.

Also contemplated for models 64 is a support vector machine (SVM), singular value decomposition (SVD), deep neural network (DNN), densely connected convolutional networks (DenseNets), hidden Markov model (HMM), and Bayesian network (BN).

In some embodiments, models 64 may comprise output head 52 as part of a fast or faster R-CNN apparatus with backbone 46, RPN 48, and ROI pooling 50-1. And ROI pooling layers 50-2,50-3 with output head 54 may be combined with said apparatus to perform the herein-disclosed training process. In some embodiments, shared backbone 46 may comprise a plurality of layers of the model. And there may be, e.g., layers in other portions of the faster R-CNN apparatus. Contemplated alternatives to faster R-CNN include, e.g., (i) any suitable, two-stage detector such as region-based fully convolutional network (R-FCN), mask R-CNN, mesh R-CNN or (ii) any suitable, one-stage detector such as YOLO, recurrent YOLO (ROLO), RetinaNet, and singe shot multibox detector (SSD). In the first stage, a sparse set of region proposals may be generated (e.g., by having a polygonal bounding box of all possible objects). And a second stage may classify each proposal (e.g., by assigning a class label to each bounding box) and refine its location.

In some embodiments, one or more of the mentioned ROI pooling layers may output a softmax probability and the bounding box, which are the class and position of the object, respectively. These layers may, e.g., perform quantization of the ROIs, which includes rounding the floating-point values to decimal values in the resulting feature map. And they may extract fixed-length feature vectors of the corresponding ROIs, from the network's output tensor. These layers may also, e.g., scale a slice of the feature map to some pre-defined size (e.g., 7×7). For example, ROI pooling 50 may provide only the feature vectors of the output backbone tensor that correspond only to the particular subregion that is designated by the outline of an object (e.g., a candidate, foreground object or a support object).

In some embodiments, weights of backbone neural network 46 may be shared, e.g., when training with positive-support and negative-support content items 42,44 and when newly-obtaining query image 40-2 post deployment. This weight-shared framework may comprise multiple branches, where one branch is for the query set and the others are for the positive and negative support sets. And this framework may be used to train the matching relationship between support and query features, to make the network learn general knowledge among the same categories.

In some embodiments, shared backbone 46 may provide a plurality of features or feature vectors. Backbone 46 may, e.g., be a deeper and densely connected backbone (e.g., ResNet, ResNeXt, AmoebaNet, AlexNet, VGGNet, Inception, etc.) or a more lightweight backbone (e.g., MobileNet, ShuffleNet, SqueezeNet, Xception, MobileNetV2, etc.), but any suitable neural network, feature extractor network, or convolutional network (e.g., CNN) is contemplated for this model. As such, backbone 46 may, e.g., compute features from an input image (e.g., query content 40-1, positive support image 42, and negative support image 44), and then these features may, e.g., be upsampled by a decoder module to generate segmented masks. The losses may be optimized for during training (e.g., as a weighted sum of the individual losses), for prediction heads 52 and/or 54. As such, an additional set of losses may be added (with respect to faster R-CNN) for training, e.g., which may be cross entropy for similarity head 54 because this head may just be predicting whether there is a match.

In some embodiments, backbone network 46 may extract a feature map from each image, e.g., which contains higher level summarized information. Prediction head 52 may, e.g., use convolutional feature maps (and/or activations) resulting from the query image to predict presence of an object therein, and similarity head 54 may, e.g., use convolutional feature maps (and/or activations) resulting from support images 42 and 44. These heads may use such features, after the respective ROI pooling function is performed. For example, ROI pooling layer 50-2 may output the features that are associated with a particular subregion of positive support image 42, and, when training, ROI pooling layer 50-3 may output the features that are associated with a particular subregion of negative support image 44.

In some embodiments, RPN 48 may be configured to obtain feature vectors and create class-agnostic region proposals by sliding a small network or filter over a last (e.g., shared) convolution layer of the network. In this example, the small network may have as input a window (e.g., n×n) of the convolutional feature map. Each sliding window may be mapped to a lower-dimensional feature and provided to fully connected layer(s) of object prediction head 52. RPN 48 may, e.g., take as input query image 40 (e.g., of any size) and output a set of polygonal object proposals, each having an abjectness score.

In some embodiments, object prediction head 52 may implement a box-classification and box-regression layer. For example, object prediction head 52 may perform regression and classification. More particularly, object prediction head 52 may have a regression layer for predicting the box parameters of all proposals, and this head may have a classification layer for predicting the object background probabilities of all proposals.

For each location in the feature maps, RPN 48 may, e.g., make k guesses. Therefore, RPN 48 may output 4×k coordinates and 2×k scores per location. To make k predictions per location, there may be k anchors centered at each location. Each prediction is associated with a specific anchor, but different locations may share the same anchor shapes. In some embodiments, the anchors may be preselected and diverse, e.g., to cover real-life objects at different scales and aspect ratios reasonably well. This may guide the initial training with better guesses and allow each prediction to specialize in a certain shape. Proposal generation may, e.g., include attaching 9 anchors centered at each point of the convolutional feature map (e.g., 3 for detecting various object types and 3 scales for dealing with scaling variance). RPN 48 may predict one proposal with 6 parameters with respect to each anchor. The RPN may be trained, e.g., end-to-end by backpropagation and/or stochastic gradient descent (SGD).

RPN 48 may be, e.g., a fully convolutional network that efficiently predicts region proposals with a wide range of scales and aspect ratios. That is, RPN 48 may provide candidate regions within the features generated by backbone 46 that make an object of interest. Each bounding box may contain, e.g., an object and also the category (e.g., car, person, cat, tree, etc.) of the object. But models 64-1 may be trained with a targeted dataset having objects that are relevant to the particular application or field of use. And by virtue of that, system 10 may learn appropriate features for the intended prediction.

The candidate regions from RPN 48 may, e.g., be provided to ROI pooling layer 50-1, which may output the features that are associated with the corresponding subregions of the query image. That is, an output of this pooling layer may comprise only of features coming out of the neural network for candidate subregions, and thus not any of the features from any other subregion.

In some embodiments, similarity head 54 may compare similarity across the sub-regional features of support image 42 (and of negative support image 44, during training) with the sub-regional features from all of the candidate objects. More particularly, the similarity may be determined via a suitable distance function (e.g., Euclidean, cosine, Hamming, Manhattan, Minkowski, Tanimoto, Jaccard, Mahalanobis, etc.), in the feature space between the feature representations of each one of the objects. As such, models 64-1 may be learning how to better perform the similarity comparisons during the training process. RPN 48 may, e.g., be trained with image dataset 62 from which an image is randomly selected. The anchors may each be labeled with a class (e.g., as ground truth (GT)) and then sampled (e.g., resulting in a mini-batch). A loss may be computed for back propagation. And the intersection over union (IoU) function may be performed for measuring box overlap. In some embodiments, positive GT matches from RPN and background samples may be provided to similarity model 54, as depicted in FIG. 2. Accordingly, models 64 may be used to exploit similarity between a few shot support set and a query set to detect novel objects, while suppressing false detection in the background.

In some embodiments, similarity head 54 may determine a similarity score by comparing features derived from the support images with features derived from the region proposals. And this head may determine whether each of the similarity scores satisfies a criterion to discard region proposals (i.e., of candidate objects) associated with those scores that do not so satisfy.

In some embodiments, models 64-2 may predict presence of an unseen object by RPN 48 respectively detecting a first region (e.g., subregions 80, 82-1, 82-2, and 82-3) of each of at least the unseen object (e.g., tank 81) and every single candidate object (e.g., people 83-1,83-2 and car 83-3). Next, models 64-2 may detect, from among the first regions, an object having a regional similarity score that satisfies a criterion with respect to positive-support content item 42. Then, system 10 may display (e.g., via user interface 18) only a bounding box for the region in which the latter object (e.g., tank 81) is detected to be present. The latter detection is performed by determining a regional similarity score between each of all candidate objects and the positive-support content item; this detection may be further performed by keeping only the regional proposal(s) having the highest similarity score and/or having a similarity score that satisfies the criterion. In other words, only the regional proposal, which is sufficiently close in terms of visual characteristics to visual characteristics of the support image that the user previously provided, may be displayed. The other bounding boxes that do not have such close feature representations may not be displayed.

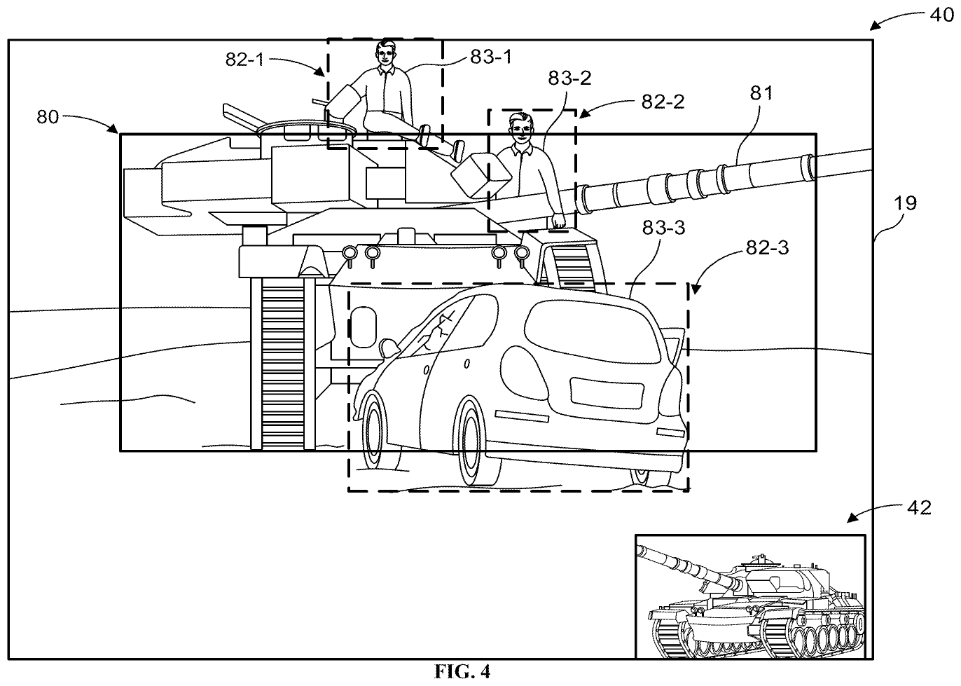

FIG. 4 depicts example predictions made by models 64-2 that are displayed on screen or display 19. More particularly, all of the boxes (i.e., 80, 82-1, 82-2, and 82-3) within query image 40 may be candidate regions proposed by RPN 48. Said boxes with dotted lines 82-1, 82-2, and 82-3 represent intermediate proposals that similarity head 54 discards due to their having similarity scores that each do not satisfy a criterion. And said box with solid line 80 may represent a final proposal that similarity head 54 provides to UI interface 18 for displaying to a user. That is, query image(s) 40 may be displayed with only predicted bounding box 80 around the previously unseen tank (e.g., and optionally with positive support content item 42 at an edge of the screen).

FIG. 3 depicts models 64-2 in a configuration post training or upon deployment. These models may include trained backbone 46, object prediction head 52, and similarity head 54, and they may lack the lower branch of FIG. 2 (i.e., the training branch that comprises processing of negative support content item 44). In some embodiments, object prediction head 52 may be configured to propose and refine bounding box coordinates by re-scoring proposals and by performing class recognition (or by determining that the proposal contains only background).

In some embodiments, object prediction head 52 may, after performing non-max suppression (NMS), make a prediction of a subregion around each candidate object. For example, NMS may be used, e.g., when the highest scoring object deletes its nearby objects with inferior classification scores. In this or another example, NMS may be used to take a list of proposals sorted by score and iterate over the sorted list, discarding those proposals that have an IoU larger than a predefined threshold with a proposal that has a higher score. In other words, NMS may be used, e.g., to remove bounding boxes that overlap with each other more than a predefined IoU threshold. NMS may thus remove duplicate detections, reducing false positives. And contemplated variants of NMS include GreedyNMS, Fitness NMS, Soft-NMS, MaxpoolNMS, conv-net, or another suitable unit.

In some embodiments, models 64-2 may immediately, upon deployment, make predictions because no further retraining is needed. That is, none of the weights of the model may need retuning or subsequent fine-tuning.

Although query images are defined herein to be newly-obtained content and though FIG. 2 depicts a training procedure with query image input 40-1, query content 40-1 may be different from query content 40-2 that may be fed into the deployed models of FIG. 3.

In some embodiments, training data 62 may be any suitable corpus of images or video, e.g., which may include hundreds or even thousands of different categories. For example, dataset 62 may have around 800 classes in the training set and 200 classes in the test set, and the classes that are in the test set may actually not be represented in the training set. So there may be no categorical overlapping between training and test, which may be significant in ascertaining whether models 64 are working properly.

In some embodiments, an amount of the positive and negative support images is floating, e.g., where each amount is variably determined by a user via UI interface 18. That is, an n-shot training paradigm may be employed. For example, system 10 may operate with just one positive support image and a plurality (e.g., 2, 3, 5, 10, 15, or more) of negative support images. In another example, system 10 may operate with a plurality (e.g., 2, 3, 5, 10, 15, or more) of positive support images but just one negative support image. And, in yet another example, system 10 may operate with the plurality of positive support images and the plurality of negative support images. In these examples, the number of support images supported by system 10 may be determined as the user feeds the image(s) into shared backbone 46 (e.g., when training models 64 or when inferring an object's presence with live data).

In implementations where more than one positive or negative support image is used, information component 30 may perform an average of their feature vectors and use this average representation in the training of shared backbone 46 and/or in the subsequent inference of an object's presence. In some embodiments, the more supports provided, the better the prediction resulting from similarity head 54.

In some embodiments, system 10 may implement 3-way contrastive training of similarity head 54. This strategy, e.g., builds training pairs between: correct predictions and positive supports; correct predictions and negative supports; and background regions from the image. For example, there may be a correct match between a positive support and a positive prediction from the original query. If there is a prediction from the query that matches with a negative support, that would be a negative match. And if a prediction matches with a background sample, this would be a null or an incorrect prediction. When deployed, the negative supports may not be further used, the negative supports being only used to train models 64-1 how to contrast better against positive and negative examples.

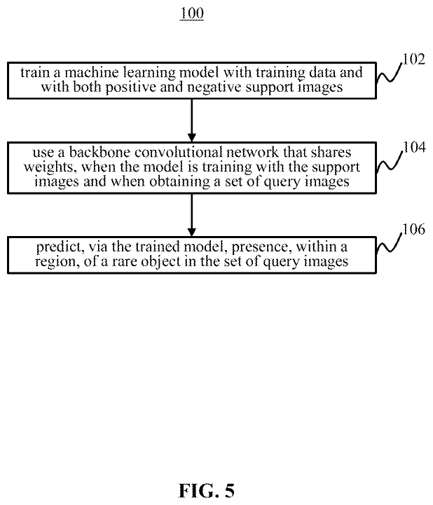

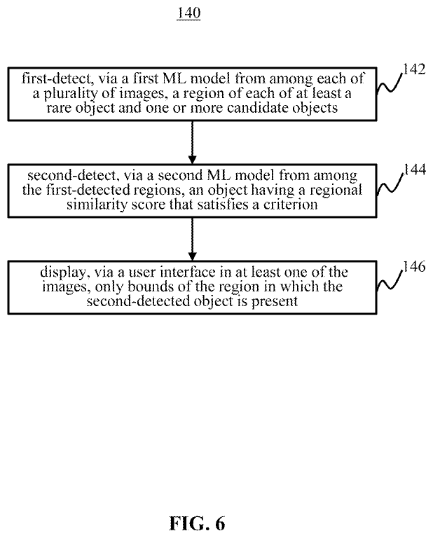

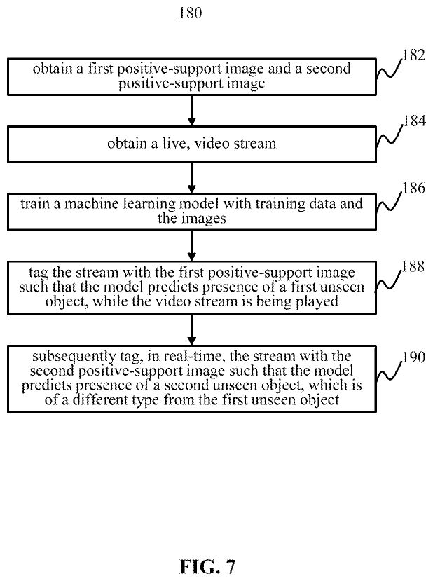

FIGS. 5-7 illustrate methods 100, 140, and 180 for predicting presence of unseen objects (e.g., from among a cluttered query image). Each of methods 100, 140, and 180 may be performed with a computer system comprising one or more computer processors and/or other components. The processors are configured by machine readable instructions to execute computer program components. The operations of methods 100, 140, and 180 presented below are intended to be illustrative. In some embodiments, methods 100, 140, and 180 may be accomplished with one or more additional operations not described, and/or without one or more of the operations discussed. Additionally, the order in which the operations of methods 100, 140, and 180 are illustrated in FIGS. 5-7 and described below is not intended to be limiting. In some embodiments, methods 100, 140, and 180 may each be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of methods 100, 140, and 180 in response to instructions stored electronically on an electronic storage medium. The processing devices may include one or more devices configured through hardware, firmware, and/or software to be specifically designed for execution of one or more of the operations of methods 100, 140, and 180.

At operation 102 of method 100, a machine learning model may be trained, with training data 62 and with both positive and negative support images 42,44. In some embodiments, operation 102 is performed by a processor component the same as or similar to training component 32 and models 64-1 (shown in FIGS. 1-2 and described herein).

At operation 104 of method 100, a backbone convolutional network may be used. For example, network 46 may share weights, when models 64-1 is training with support images 42,44 and when models 64 is obtaining a set of query images 40. In some embodiments, operation 104 is performed by a processor component the same as or similar to training component 32 and models 64-1 (shown in FIGS. 1-2 and described herein).

At operation 106 of method 100, presence, within a region, of a rare object in the set of query images may be predicted, via the trained model. As an example, the rare object may satisfy a uniqueness or rarity criterion that is higher than a uniqueness or rarity criterion of objects in negative-support content 44. In some embodiments, operation 106 is performed by a processor component the same as or similar to inference component 34 and models 64-2 (shown in FIGS. 1-2 and described herein).

At operation 142 of method 140, a region of each of at least a rare object and one or more candidate objects may be first-detected, via a first ML model, from among each of a plurality of images. In some embodiments, operation 142 is performed by backbone 46, RPN 48, ROI pooling 50-1, and object detection head 52 (shown in FIG. 2 and described herein).

At operation 144 of method 140, an object having a regional similarity score that satisfies a criterion may be second-detected, from among the first-detected regions via a second ML model. In some embodiments, operation 144 is performed by backbone 46, ROI pooling 50-2, and similarity head 54 (shown in FIG. 2 and described herein).

At operation 146 of method 140, only bounds of the region in which the second-detected object is present may be displayed, in at least one of the images via a user interface. In some embodiments, operation 146 is performed by UI interface 18 (shown in FIG. 1 and described herein).

At operation 182 of method 180, a first positive-support image and a second positive-support image may be obtained. In some embodiments, operation 182 is performed by a processor component the same as or similar to information component 30 (shown in FIG. 1 and described herein).

At operation 184 of method 180, a live, video stream may be obtained. In some embodiments, operation 184 is performed by a processor component the same as or similar to information component 30 (shown in FIG. 1 and described herein).

At operation 186 of method 180, a machine learning model may be trained, with training data and the images. In some embodiments, operation 186 is performed at least by a processor component the same as or similar to training component 32 (shown in FIG. 1 and described herein).

At operation 188 of method 180, the video stream with the first positive-support image may be tagged such that the model predicts presence of a first unseen object, while the stream is being played. In some embodiments, operation 188 is performed by UI interface 18 and models 64-2 (shown in FIGS. 1-2 and described herein).

At operation 190 of method 180, the video stream may be subsequently tagged (e.g., in real-time), with the second positive-support image such that the model predicts presence of a second unseen object, which is of a different type from the first unseen object. In some embodiments, operation 190 is performed by UI interface 18 and models 64-2 (shown in FIGS. 1-2 and described herein).

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the disclosure are specifically illustrated and/or described herein. However, it will be appreciated that modifications and variations are contemplated and within the purview of the appended claims.

What is claimed is:

1. A method for detecting an unseen object, the method comprising:
obtaining a positive-support content item and a plurality of training data, each datum comprising one or more content items;
training a machine learning model with the training data and the positive-support content item; and
predicting, via the trained machine learning model, presence, within a region, of an object in a newly-obtained content item,
wherein the object (i) has not previously been used to train the model and (ii) is among a background and a candidate object present in the newly-obtained content item.

2. The method of claim 1, wherein the prediction is based on the region matching a region of the positive-support content item.

3. The method of claim 1, wherein the model is further trained with a negative-support content item.

4. The method of claim 3, wherein the positive-support content item is previously provided by a user of a system performing the object detection, and
wherein the negative support content item comprises objects the presence of which the model is not intended to predict.

5. The method of claim 3, wherein weights of a backbone neural network are shared, when the model is (i) training with the positive-support and negative-support content items and (ii) obtaining the newly-obtained content items.

6. The method of claim 1, wherein the prediction is made without having to retune any weights of the model subsequent to the training.

7. The method of claim 2, wherein the object is depicted, in the newly-obtained content item, differently from the object's depiction, in the positive-support content item.

8. The method of claim 7, wherein the different depictions of the object (i) comprise a different background, (ii) comprise different instances of a same type of the object, and/or (ii) are captured at different times.

9. The method of claim 2, wherein the prediction comprises:
first-detecting a region of each of at least the object and the candidate object;
second-detecting, from among the first-detected regions, an object having a regional similarity score that satisfies a criterion with respect to the positive-support content item; and
displaying, via a user interface, only the region in which the second-detected object is present.

10. The method of claim 9, wherein the second-detection is performed by determining a regional similarity score with respect to each of all candidate objects and the positive-support content item.

11. The method of claim 10, wherein the model comprises a faster recurrent convolutional neural network (R-CNN) to which are coupled a pair of region of interest (ROI) pooling layers and a similarity model that computes the similarity scores.

12. The method of claim 1, wherein the newly-obtained content item comprises a series of time-sequential images or video.

13. The method of claim 3, wherein the object satisfies a uniqueness or rarity criterion that is higher than a uniqueness or rarity criterion of objects in the negative-support content item.

14. A method for detecting an unseen object, the method comprising:
first-detecting, via a first machine learning model from among each of a plurality of images, a region of each of at least the unseen object and a candidate object;
second-detecting, via a second machine learning model operably coupled to the first machine learning model, and from among the first-detected regions, an object having a regional similarity score that satisfies a criterion with respect to a positive-support content item; and
displaying, via a user interface in the plurality of images, only bounds of the region in which the second-detected object is present.

15. The method of claim 14, wherein the second-detection is performed by determining a regional similarity score with respect to each of all candidate objects and the positive-support content item.

16. The method of claim 14, wherein the first model is trained with training data, a positive-support image, and a negative-support image.

17. The method of claim 16, wherein the positive-support image is previously provided by a user of a system performing the object detection, and
wherein the negative support image comprises objects the presence of which the second model is not intended to predict.

18. The method of claim 16, wherein weights of a backbone neural network are shared, when (i) training with the positive-support and negative-support images and (ii) newly-obtaining the plurality of images.

19. A method, comprising:
obtaining a first positive-support image and a second positive-support image;
obtaining a real-time video stream;
training a machine learning model with training data and the images;
tagging the stream with the first positive-support image such that the model predicts presence of a first object, while the video stream is being played; and
subsequently tagging, in real-time, the stream with the second positive-support image such that the model predicts presence of a second object,
wherein neither the first nor second object has been used to perform the training, and wherein the first and second objects are of a different type.

20. The method of claim 19, wherein the method further comprises obtaining a negative-support image such that the model is further trained with the negative-support image, and
wherein each of the first and second objects satisfies a uniqueness or rarity criterion that is higher than a uniqueness or rarity criterion of objects in the negative-support image.
